(19) United States
(12) Patent Application Publication
(10) Pub. No.: US 2014/0026722 A1
(43) Pub. Date: Jan. 30, 2014

(54) Locking pliers with torque display arrangement

(71) Applicant: Wei-Li Chen, Taichung (TW)

(72) Inventor: Wei-Li Chen, Taichung (TW)

(21) Appl. No.: 13/561,091

(22) Filed: Jul. 30, 2012

(51) Int. Cl. B25B 7/14

(52) U.S. Cl. 81/415

(57) ABSTRACT

A locking pliers is provided with first and second plier arms each including a jaw and a handle portion; a pivot joint interconnecting the first and second plier arms for allowing movement of the jaws from an open position to a closed position; and a link and quick release assembly including a link having one end pivotably secured to one handle portion; a spring biased quick release lever put on the link; and a housing having one end connected to the quick release lever and the other end pivotably secured to the other handle portion, the housing including a main portion with the link disposed therein, the main portion including at least three marks. In response to pressing the first and second handle portions toward each other, the other end of the link moves to a mark other than the first and last marks.

### BACKGROUND OF THE INVENTION

1. Field of the Invention

The invention relates to locking pliers and more particularly to a locking pliers having a torque display arrangement.

2. Description of Related Art

Locking pliers are pliers that can be locked into position by using an over-center action. A typical type of locking pliers comprises on one side of the handle a bolt that is used to adjust the spacing of the jaws. The other side of the handle often includes a lever to push the two sides of the handles apart to unlock the pliers.

Locking pliers are available in many different configurations, such as needle-nose locking pliers, locking wrenches, locking clamps and various shapes to fix metal parts for welding. They also come in many sizes.

A conventional locking pliers is shown in FIG. 1 and comprises a first handle 1a, a second handle 2a, and a link and quick release assembly 3a comprising a link 4a having one end pivotably secured to the first handle 1a, a hollow housing 5a having one end pivotably secured to the second handle 2a, the housing 5a including an extension 51a facing the first handle 1a, and a bent quick release lever 7a including a through hole 8a proximate one end 7a1 which is pivotably secured to the extension 5a1 at a pivot joint 5a2, and a torsion spring 6a biased between the through hole 8a and the opening of the housing 5a to render the quick release lever 7a to be a spring biased member and thus pivotal about the pivot joint 5a2. The link 4a has a width less than a diameter of the through hole 8a, an inner diameter of the spring 6a, and a width of the interior space of the housing 5a. Thus, the link 4a can be inserted through the through hole 8a and the spring 6a into the housing 5a. Further, a portion of the link 4a is allowed to freely move within the housing 5a. In a closed position of the locking pliers, the link 4a is urged against an inner surface of the through hole 8a for being locked due to the expansion of the spring 6a. However, the pivotal connection of the quick release lever 7a and the extension 5a1 (i.e., the housing 5a) is not reliable. Thus, the desired locking of the link 4a in the closed position fails after a short period of time of use.

Another conventional locking pliers is shown in FIG. 2 and comprises a first handle 1b, a second handle 2b, and a link and quick release assembly 3b comprising a link 4b having one end pivotably secured to the first handle 1b, a hollow housing 5b having one end pivotably secured to the second handle 2b, the housing 5b including an extension 9b facing the first handle 1b, and a bent quick release lever 7b including a through hole 8b proximate one end which is pivotably secured to the extension 9b at a pivot joint 9b1, and a torsion spring 6b biased between the through hole 8b and the opening of the housing 5b to render the quick release lever 7b to be a spring biased member and thus pivotal about the pivot joint 9b1. The link 4b inserts through the through hole 8b and the spring 6b into the housing 5b. The link 4b has a width less than a diameter of the through hole 8b so that the link 4b is allowed to freely insert through the through hole 8b. In a closed position of the locking pliers, the link 4b is urged against an inner surface of the through hole 8b for being locked due to the expansion of the spring 6b. However, a problem encountered by users of this conventional locking pliers is that the user cannot see the length of the link 4b inserted into the housing 5b because the housing 5b is not transparent. Further, there is no arrangement on the housing 5b for displaying torque being applied in use. Thus, overtightening an object gripped by the jaws may occur. Furthermore, there are no conventional locking pliers with a torque display arrangement as far as the present inventor is aware. Thus, the need for improvement still exists.

### SUMMARY OF THE INVENTION

It is therefore one object of the invention to provide a locking pliers comprising a first plier arm comprising a forward first jaw and a rearward first handle portion; a second plier arm comprising a forward second jaw and a rearward second handle portion; a pivot joint interconnecting the first and second plier arms for allowing movement of the first and second jaws from an open position to a closed position; and a link and quick release assembly comprising a link having one end pivotably secured to the second handle portion; a spring biased quick release lever put on the link; and a housing having one end connected to the quick release lever and the other end pivotably secured to the first handle portion, the housing comprising a main portion with the link disposed therein, the main portion including at least three marks; wherein in the closed position, the other end of the link is disposed at the last one of the marks proximate the first handle portion; wherein in the open position with an object held by the first and second jaws, the other end of the link is disposed at the first one of the marks proximate the second handle portion; and wherein in response to pressing the first and second handle portions toward each other, the first and second jaws move toward each other to grip the object and the other end of the link moves to one of the marks other than the first and the last marks.

The above and other objects, features and advantages of the invention will become apparent from the following detailed description taken with the accompanying drawings.

### BRIEF DESCRIPTION OF THE DRAWINGS

FIG. 1 is a side elevation of a conventional locking pliers with the jaws broken away;

FIG. 2 is a side elevation of another conventional locking pliers with the jaws broken away;

FIG. 3 is a side elevation of a locking pliers according to the invention;

FIG. 4 is an exploded view of the link and quick release assembly with a first preferred embodiment of the housing shown;

FIG. 5 is a sectional view of FIG. 3 with the jaws broken away;

FIG. 6 is a side elevation in part section of the locking pliers with an object initially held by the jaws;

FIG. 7 is a view similar to FIG. 6 with the object gripped after pivotably moving the handle portions toward each other;

FIG. 8 is a perspective view of a second preferred embodiment of the housing; and

FIG. 9 is a perspective view of a third preferred embodiment of the housing.

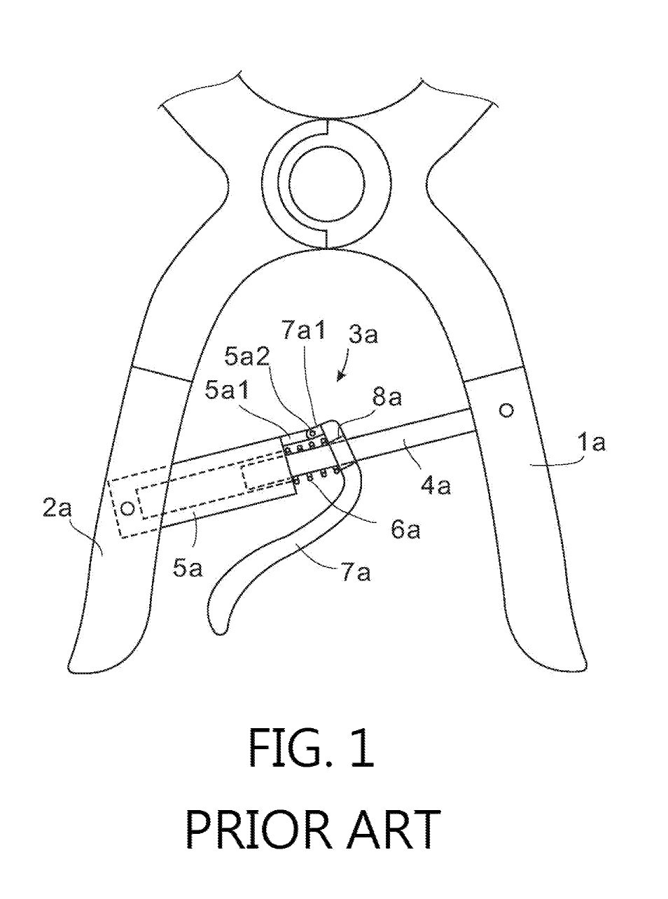

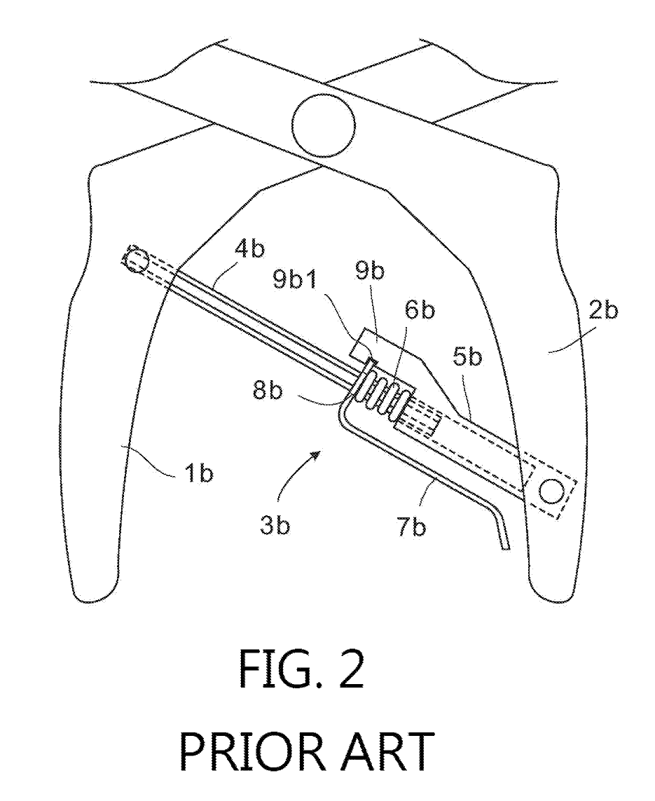

### DETAILED DESCRIPTION OF THE INVENTION

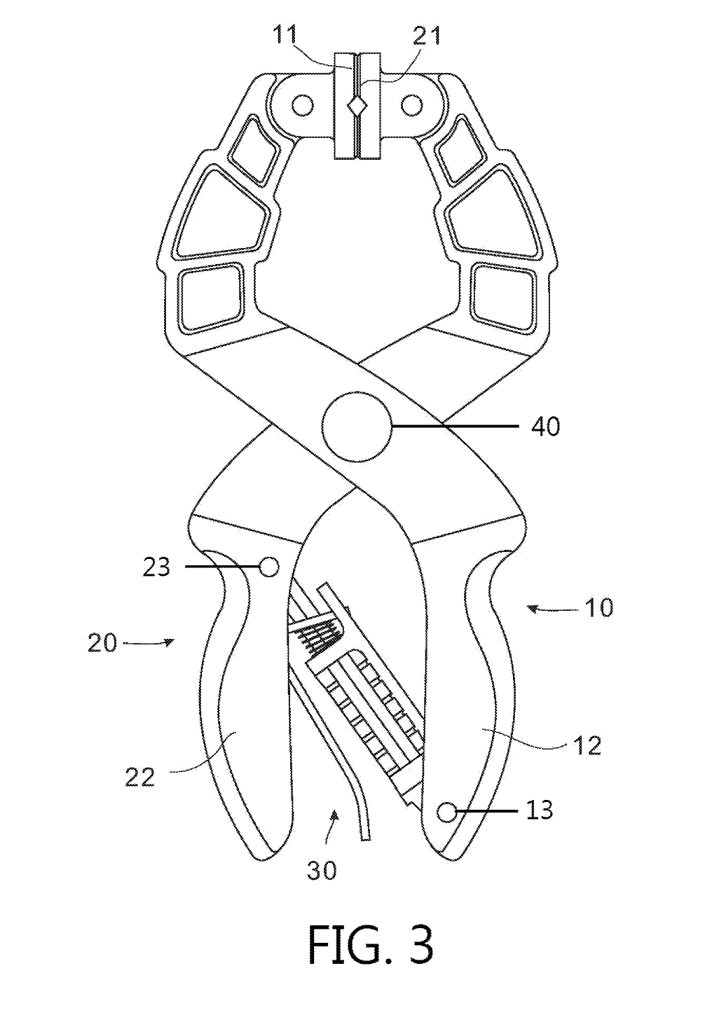

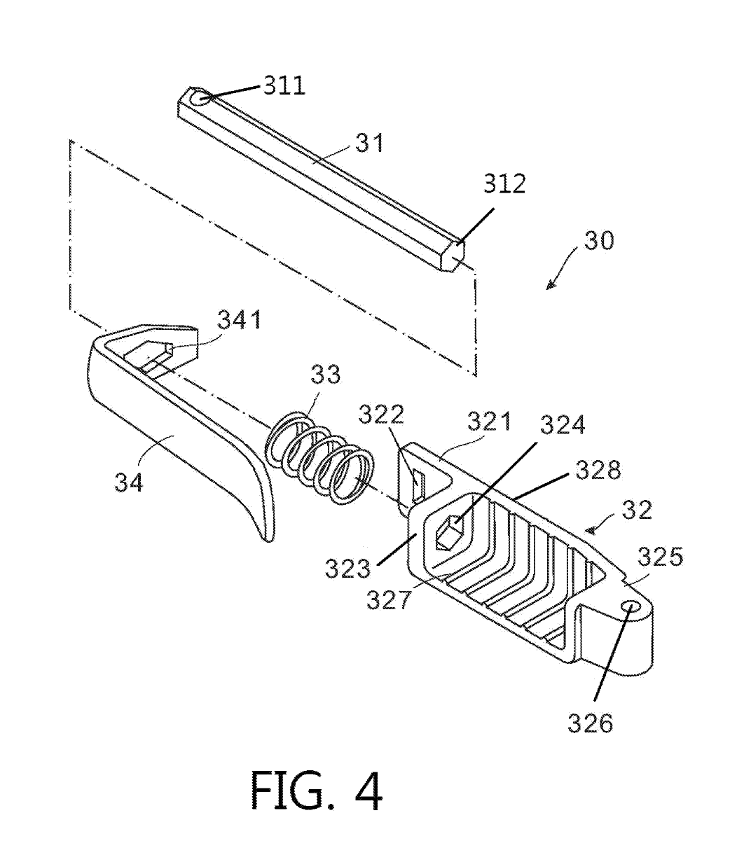

Referring to FIGS. 3 to 7, a locking pliers in accordance with the invention comprises the following components as discussed in detail below.

A first plier arm 10 comprises a forward jaw 11 and a rearward handle portion 12. A second plier arm 20 comprises a forward jaw 21 and a rearward handle portion 22. A pivot joint 40 interconnects the first and second plier arms 10, 20 for allowing movement of the jaws 11, 21 from an open position to a closed position.

A link and quick release assembly 30 comprises a hexagonal link 31 including a hole 311 at one end. A first pivot joint 23 is used to driven through the handle portion 22 and the hole 311 to pivotably interconnect the handle portion 22 and the link and quick release assembly 30. The link and quick release assembly 30 further comprises a housing 32 of a first preferred embodiment. The housing 32, as the subject of the invention, comprises a front extension 321, a slot 322 through the extension 321, a forward wall 323, a hole 324 through the wall 323, a rear projection 325, and a hole 326 through the projection 325 so that a second pivot joint 13 can be used to driven through the handle portion 12 and the hole 326 to pivotably interconnect the handle portion 12 and the link and quick release assembly 30. The housing 32 further comprises a plurality of (6 being shown) bent ridges (served as marks) 327 of regular intervals formed on an inner surface of a main portion 328 between the wall 323 and the projection 325.

The link and quick release assembly 30 further comprises a bent quick release lever 34 including a through hole 341 proximate one end which is disposed in the slot 322, and a torsion spring 33 biased between the through hole 341 and the wall 323. The link 31 has a width less than a diameter of the through hole 341, an inner diameter of the spring 33, and a width of hole 324. Thus, the link 31 can be inserted through the through hole 341 and the spring 33 into the main portion 328 of the housing 32. Further, a portion of the link 31 is allowed to freely move within the main portion 328 of the housing 32.

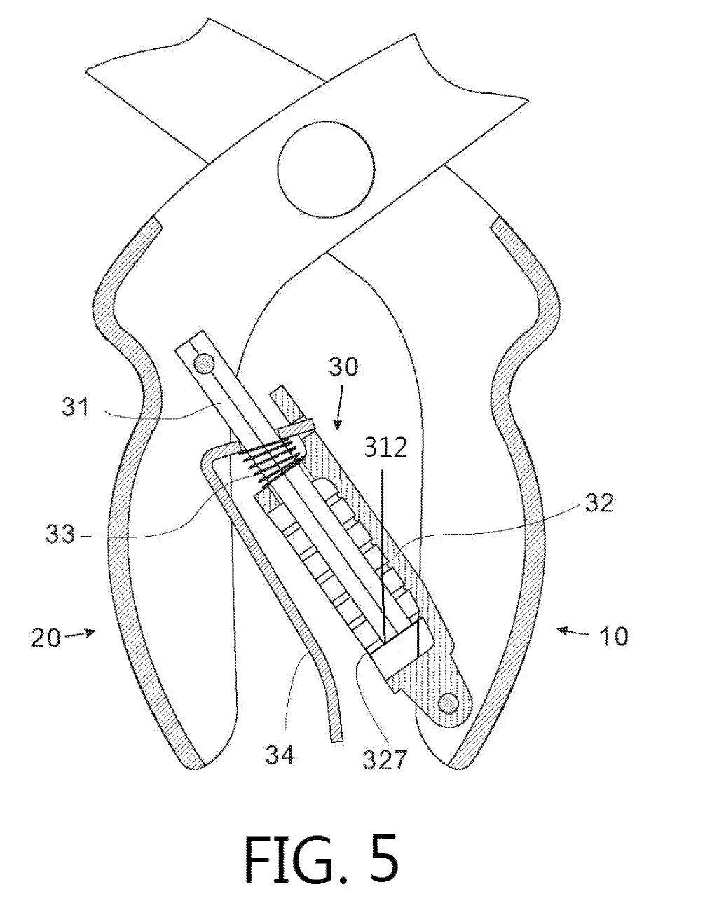

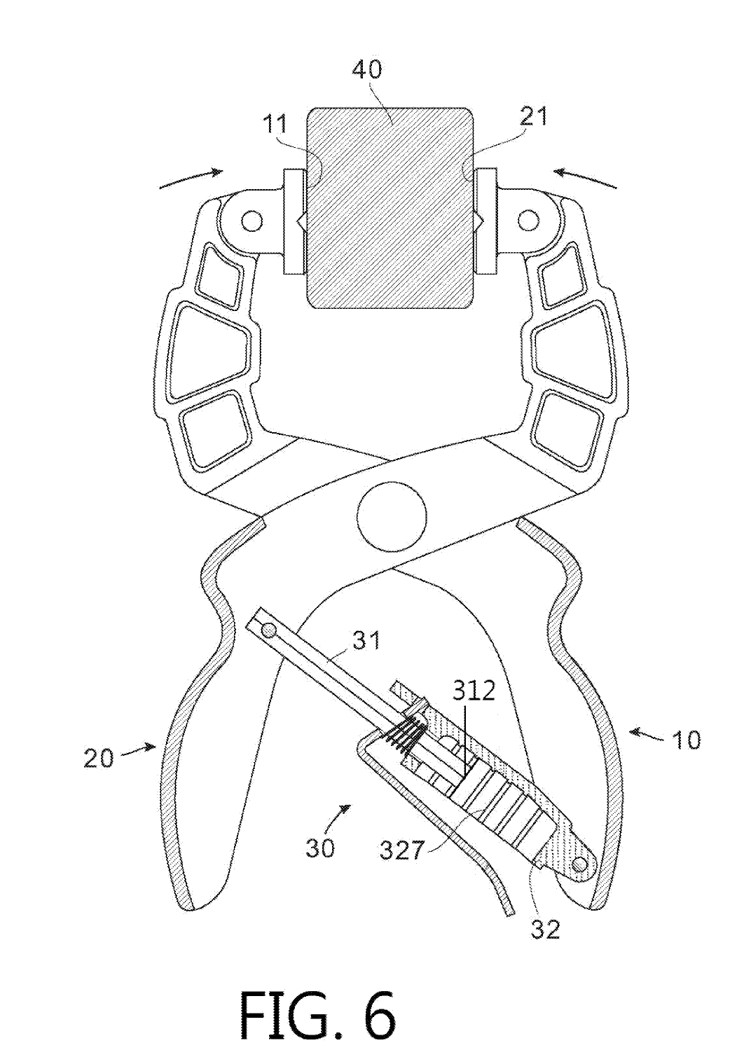

In a closed position of the locking pliers, the link 31 is urged against an inner surface of the through hole 341 for being locked due to the expansion of the spring 33, and the other end 312 of the link 31 is disposed at the last ridge 327 (i.e., the sixth one of the ridges 327 counting from left of FIG. 5). A person may press the quick release lever 34 to compress the spring 33 in order to unlock the link 31. Next, the person may open the jaws 11, 21. In a maximum spacing of the jaws 11, 21 with an object 40 held therebetween (see FIG. 6), the other end 312 of the link 31 is disposed at the second ridge 327.

Preferably, force exerted on an object being gripped should be less than a predetermined value (i.e., preset maximum torque) so as to not allow the link 31 to move more than one interval between two adjacent ridges 327. Otherwise, the locking pliers may be malfunctioned. However, more than one interval as a mark of safe maximum torque is possible in other embodiments.

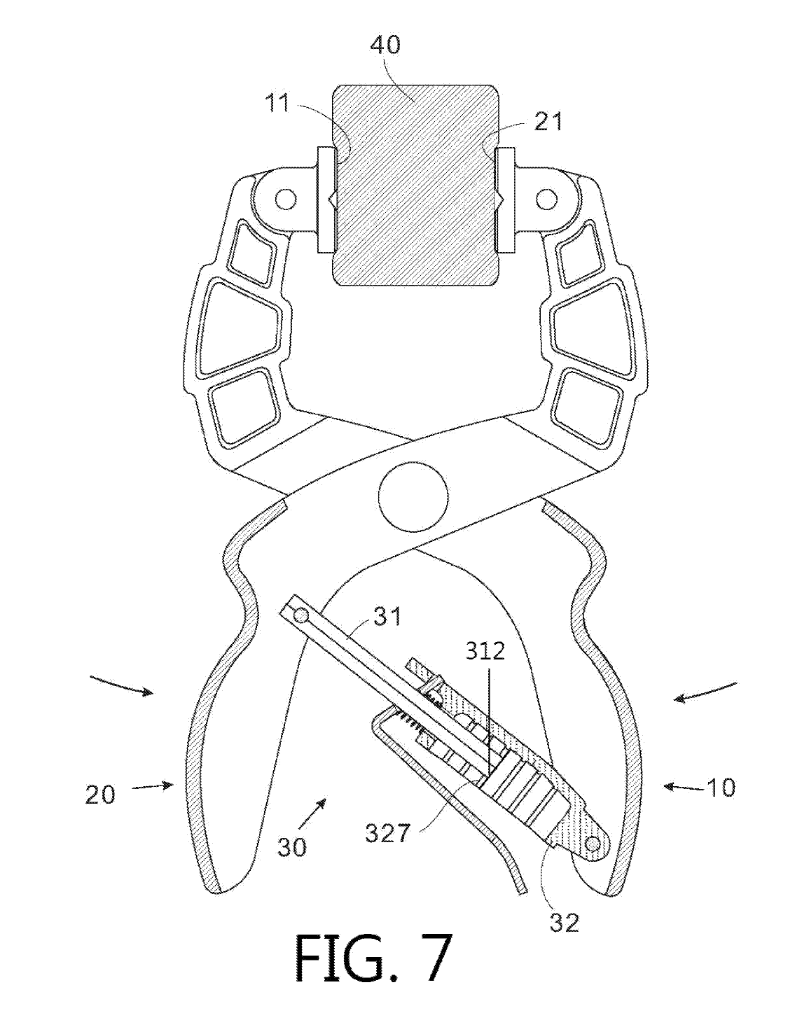

A person may press the handle portions 12, 22 toward each other (see FIG. 7). Thus, the jaws 11, 21 move toward each other to grip the object 40. After the other end 312 of the link 31 moving to the third one of the ridges 327, the person has to stop exerting force now. Otherwise, an overtightening of the object 40 may occur and this is undesired.

It is envisaged by the invention that a person may know when to stop exerting gripping force by watching the movement of the link 31 in the main portion 328 of the housing 32.

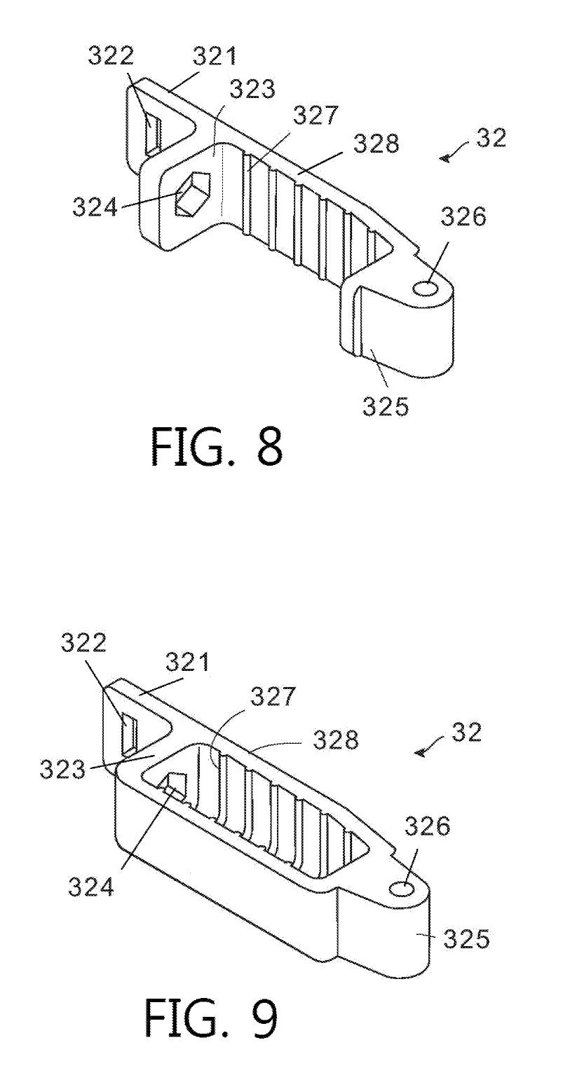

Referring to FIG. 8, a housing 32 in accordance with a second preferred embodiment of the invention is shown. The characteristics of the second preferred embodiment are substantially the same as that of the first preferred embodiment except the following: The main portion 328 of the housing 32 is a rectangular plate and the ridges 327 are straight.

Referring to FIG. 9, a housing 32 in accordance with a third preferred embodiment of the invention is shown. The characteristics of the third preferred embodiment are substantially the same as that of the first preferred embodiment except the following: The main portion 328 of the housing 32 is an open container and the ridges 327 are U-shaped.

While the invention has been described in terms of preferred embodiments, those skilled in the art will recognize that the invention can be practiced with modifications within the spirit and scope of the appended claims.

What is claimed is:

1. A locking pliers comprising:
a first plier arm comprising a forward first jaw and a rearward first handle portion;
a second plier arm comprising a forward second jaw and a rearward second handle portion;
a pivot joint interconnecting the first and second plier arms for allowing movement of the first and second jaws from an open position to a closed position; and
a link and quick release assembly comprising a link having one end pivotably secured to the second handle portion; a spring biased quick release lever put on the link; and a housing having one end connected to the quick release lever and the other end pivotably secured to the first handle portion, the housing comprising a main portion with the link disposed therein, the main portion including at least three marks;
wherein in the closed position, the other end of the link is disposed at the last one of the marks proximate the first handle portion;
wherein in the open position with an object held by the first and second jaws, the other end of the link is disposed at the first one of the marks proximate the second handle portion; and
wherein in response to pressing the first and second handle portions toward each other, the first and second jaws move toward each other to grip the object and the other end of the link moves to one of the marks other than the first and last marks.
